(19) United States
(12) Patent Application Publication
(10) Pub. No.: US 2016/0132828 A1
(43) Pub. Date: May 12, 2016

(54) REAL-TIME CONTINUOUS REALIGNMENT OF A LARGE-SCALE DISTRIBUTED PROJECT

(71) Applicant: International Business Machines Corporation, Armonk, NY (US)

(72) Inventors: Sharon I. Hartung, Burnaby (CA); Jorge L. Hernandez, Burlington (CA); Dawn M. Kierstead, Cumberland Bay (CA); Theresa M. Mah, Beaumont (CA)

(21) Appl. No.: 14/538,953

(22) Filed: Nov. 12, 2014

(51) Int. Cl. G06Q 10/10; G06F 17/30; G06Q 10/06

(52) U.S. Cl. CPC G06Q 10/103; G06Q 10/06393; G06F 17/30592

(57) ABSTRACT

A method and associated systems for real-time continuous realignment of a large-scale distributed project. A project-management system, consisting of a computer system, a data warehouse, and remote data-aggregation subsystems, receives project artifacts that describe goals, scope, contractual obligations, and other characteristics of a large-scale project. The distributed system extracts from the artifacts baseline values of benchmarks that measure project progress. Project workers located at multiple sites continuously feed the project-management system, via the data-aggregation subsystems, data describing actual progress on the project. The baseline values and actual-progress values are imported into the data warehouse in a compatible format. The data-warehouse data is then used to generate recommendations intended to resolve problems indicated by the current-progress values, which are then communicated to project managers, who implement them as action plans. The procedure repeats until benchmarks indicate that project parameters have been realigned so as to ensure desired project results.

### TECHNICAL FIELD

The present invention relates to providing interactive real-time analysis and recommendations to distributed project teams.

### BACKGROUND

A large project may be expected to satisfy hundreds or thousands of contractual obligations. Fulfilling these obligations may require independent of joint efforts of large numbers of project team members located at numerous geographically remote sites. These team members may be employed by different businesses or by different units of a same business; may be required to conform to different procedures, conventions, or standards; and may work with different types of heavy machinery or hardware components, tracking or reporting tools, computer environments, communications infrastructures, software applications, or other types of resources.

Known techniques of project management allow managers to monitor the progress of each subproject of such a project and to periodically adjust resource allocations or revise previously committed obligations in response to reports of team members' actual progress toward achieving a goal or contractual obligation of the project.

Many large, distributed projects comprise mission-critical tasks or must satisfy sensitive timing requirements in order to properly sequence completions of ordered, prioritized, or concurrent milestones. In some cases, a milestone or a set of milestones may also require coordinated efforts of project teams working independently at different sites.

Known project-management strategies are not able to provide the interactive, real-time, or near-real-time performance necessary to meet such requirements. Manual aggregation filtering, organizing, and analysis of information related to a large project would require an unacceptable duration of time, especially when that information must be obtained from multiple sites that may employ different methods of recording, storing, and formatting data. Allowing a project manager to perform such tasks with the aid of a generic computer and enterprise network would not significantly streamline this cumbersome process.

Consequently, although known methods may theoretically allow a project manager to manually gather, process, and interpret the enormous and constantly changing volumes of data that characterize a large, ongoing project, such methods cannot be performed accurately, quickly, or comprehensively enough to allow a project manager to identify bottlenecks and resource constraints, and to reallocate resources or modify project parameters in time to ensure a successful outcome.

This problem becomes even more insurmountable in real-world projects wherein dependencies, linkages, critical sequentiality, and other characteristics of project benchmarks and milestones make it hard to respond to one issue without the risk of unintended consequences that raise other issues. When multiple large projects are related or draw from common resource pools, the number of interrelated factors that must be considered when addressing such issues may be staggering.

### BRIEF SUMMARY

A first embodiment of the present invention provides distributed project-management system comprising a computer system, a data warehouse and data-warehouse server, a set of data-aggregation subsystems located at multiple distinct sites, and communications infrastructure connecting the computer system, server, and data-aggregation subsystems, wherein the computer system comprises a processor, a memory coupled to the processor, and a computer-readable hardware storage device coupled to said processor, and wherein the storage device contains program code configured to be run by the processor via the memory to implement a method for real-time continuous realignment of a large-scale distributed project, said method comprising:

a distributed project-management system accessing a set of project-related artifacts that comprises records describing goals and obligations of the project, wherein the distributed system comprises a computer system, a data warehouse and data-warehouse server, a set of data-aggregation subsystems located at multiple distinct sites, and communications infrastructure connecting the computer system, server, and data-aggregation subsystems;

the distributed system deriving a set of baseline values from the set of project-related artifacts,

wherein a first baseline value of the set of baseline values identifies a first project goal of a set of project goals, and

wherein a degree of progress toward attaining the first project goal is measured by a first benchmark of a set of project benchmarks;

the distributed system storing the set of baseline values in the data warehouse in a first data configuration;

the computer system receiving a set of project-performance records from the data-aggregation subsystems;

the distributed system extracting from the set of project-performance records a set of actual values,

wherein a first current value of the set of actual values identifies, as measured by the first benchmark, the current degree of progress toward attaining the first project goal;

the distributed system identifying, by comparing the first baseline value to the first current value, the degree of progress toward attaining the first project goal;

the distributed system conducting a project-progress analysis as a function of the identifying;

the distributed system determining, as a function of the conducting, that the current degree of progress toward attaining the first project goal is insufficient to ensure satisfaction of the first project goal; and

the distributed system, as a function of the determining, communicating a recommendation to a project manager, wherein the recommendation identifies action that should be taken by the project manager in order to ensure satisfaction of the first project goal.

A second embodiment of the present invention provides a method for real-time continuous realignment of a large-scale distributed project, the method comprising:

a distributed project-management system accessing a set of project-related artifacts that comprises records describing goals and obligations of the project, wherein the distributed system comprises a computer system, a data warehouse and data-warehouse server, a set of data-aggregation subsystems located at multiple distinct sites, and communications infrastructure connecting the computer system, server, and data-aggregation subsystems;

the distributed system deriving a set of baseline values from the set of project-related artifacts,

wherein a first baseline value of the set of baseline values identifies a first project goal of a set of project goals, and

wherein a degree of progress toward attaining the first project goal is measured by a first benchmark of a set of project benchmarks;

the distributed system storing the set of baseline values in the data warehouse in a first data configuration;

the computer system receiving from the set of data-aggregation subsystems a set of project-performance records from the data-aggregation subsystems;

the distributed system extracting from the set of project-performance records a set of actual values,

wherein a first current value of the set of actual values identifies, as measured by the first benchmark, the current degree of progress toward attaining the first project goal;

the distributed system identifying, by comparing the first baseline value to the first current value, the degree of progress toward attaining the first project goal;

the distributed system conducting a project-progress analysis as a function of the identifying;

the distributed system determining, as a function of the conducting, that the current degree of progress toward attaining the first project goal is insufficient to ensure satisfaction of the first project goal; and

the distributed system, as a function of the determining, communicating a recommendation to a project manager, wherein the recommendation identifies action that should be taken by the project manager in order to ensure satisfaction of the first project goal.

A third embodiment of the present invention provides computer program product, comprising a computer-readable hardware storage device having a computer-readable program code stored therein, said program code configured to be executed by a processor of a computer system to implement a method for real-time continuous realignment of a large-scale distributed project, the method comprising:

a distributed project-management system accessing a set of project-related artifacts that comprises records describing goals and obligations of the project, wherein the distributed system comprises a computer system, a data warehouse and data-warehouse server, a set of data-aggregation subsystems located at multiple distinct sites, and communications infrastructure connecting the computer system, server, and data-aggregation subsystems;

the distributed system deriving a set of baseline values from the set of project-related artifacts,

wherein a first baseline value of the set of baseline values identifies a first project goal of a set of project goals, and

wherein a degree of progress toward attaining the first project goal is measured by a first benchmark of a set of project benchmarks;

the distributed system storing the set of baseline values in the data warehouse in a first data configuration;

the computer system receiving a set of project-performance records from the data-aggregation subsystems;

the distributed system extracting from the set of project-performance records a set of actual values,

wherein a first current value of the set of actual values identifies, as measured by the first benchmark, the current degree of progress toward attaining the first project goal;

the distributed system identifying, by comparing the first baseline value to the first current value, the degree of progress toward attaining the first project goal;

the distributed system conducting a project-progress analysis as a function of the identifying;

the distributed system determining, as a function of the conducting, that the current degree of progress toward attaining the first project goal is insufficient to ensure satisfaction of the first project goal; and

the distributed system, as a function of the determining, communicating a recommendation to a project manager, wherein the recommendation identifies action that should be taken by the project manager in order to ensure satisfaction of the first project goal.

### BRIEF DESCRIPTION OF THE DRAWINGS

FIG. 1 shows the structure of a distributed project-management system and computer program code that may be used to implement a method for real-time continuous realignment of a large-scale distributed project in accordance with embodiments of the present invention.

FIG. 2 is a flow chart that illustrates steps of a method for real-time continuous realignment of a large-scale distributed project in accordance with embodiments of the present invention.

### DETAILED DESCRIPTION

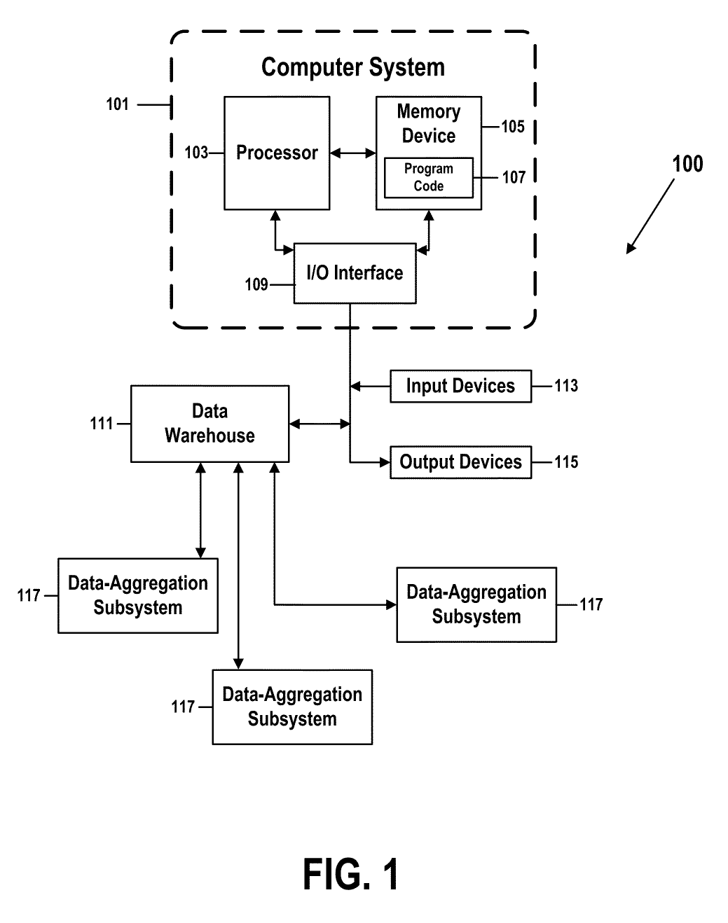

FIG. 1 shows a structure of a specialized computer system 100 and computer program code that may be used to implement a method for real-time continuous realignment of a large-scale distributed project in accordance with embodiments of the present invention. FIG. 1 comprises objects 100-117.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, generic computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

In embodiments of the present invention, one or more of the data storage devices 111 may be a data warehouse. As is known to those skilled in the art, a data warehouse is a special-purpose, integrated, central repository of data used to aggregate information culled from one or more disparate sources without requiring a traditional database-management system. As in embodiments of the present invention, information in a data warehouse may be organized, linked, and structured so as to facilitate efficient access, comparison, reporting and analysis of current and historical data.

Embodiments of the present invention may employ a data warehouse of a specialized distributed project-management system to store both baseline and current, actual information characterizing a project, and to facilitate comparison of actual progress against baseline goals. Such an automated, structural-driven methodology permits the progress of a large project to be analyzed with real-time or near-real time response. It also permits such analyses to comprehensively identify, analyze, and extrapolate an enormous numbers of related parameters that typically characterize large, distributed projects. Both of these technical advantages have not been possible with traditional project-management methods, regardless of whether those methods consist solely of human project-management activity, or of human activity supported by traditional project-management tools, such as spreadsheet programs and traditional project-management software applications.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

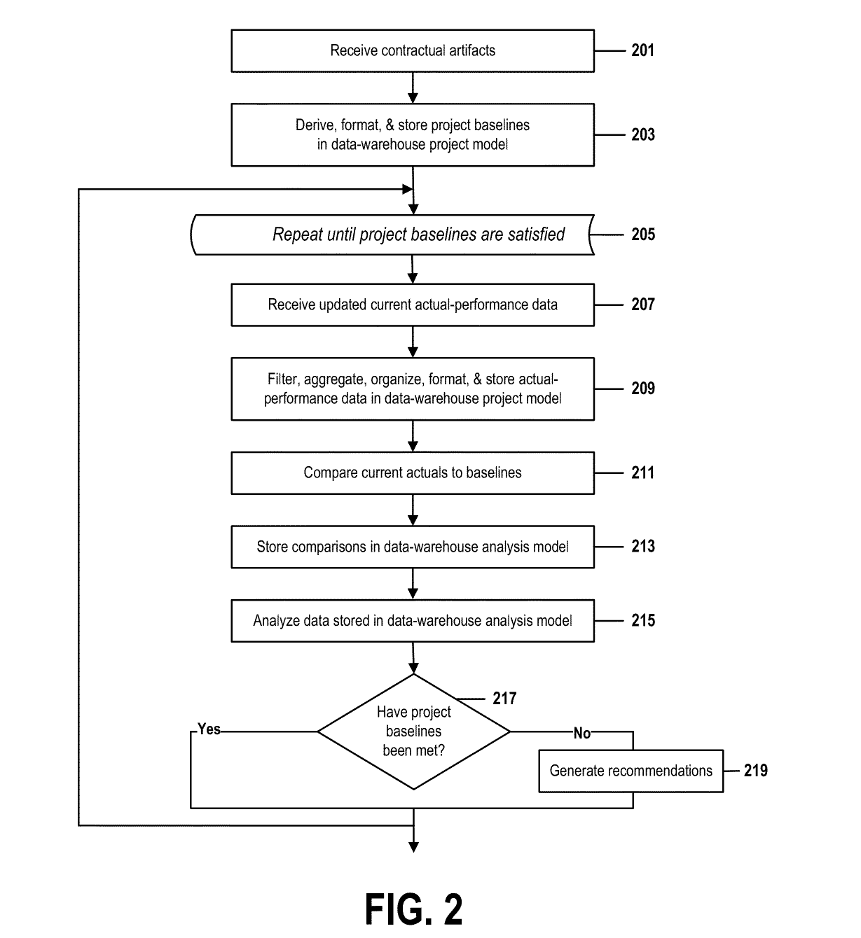

At least one memory device 105 contains stored computer program code 107, which is a computer program that comprises computer-executable instructions. The stored computer program code includes a program that implements a method for real-time continuous realignment of a large-scale distributed project in accordance with embodiments of the present invention, and may implement other embodiments described in this specification, including the methods illustrated in FIGS. 1-2. One or more data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for real-time continuous realignment of a large-scale distributed project.

Any of the components of the present invention could be created, integrated, hosted, maintained, deployed, managed, serviced, supported, etc. by a service provider who offers to facilitate a method for real-time continuous realignment of a large-scale distributed project. Thus the present invention discloses a process for deploying or integrating computing infrastructure, comprising integrating computer-readable code into the computer system 101, wherein the code in combination with the computer system 101 is capable of performing a method for real-time continuous realignment of a large-scale distributed project.

One or more of data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for cross-retail marketing based on analytics of multichannel clickstream data may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for cross-retail marketing based on analytics of multichannel clickstream data is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

The specialized computerized system of FIG. 1 further comprises one or more data-aggregation subsystems 117 that accumulate data from diverse sources and forward the accumulated data to the data warehouse.

In some embodiments, the data-aggregation subsystems 117 may physically reside at geographically remote locations, may accumulate data through any manual, electronic, or computerized means known to those skilled in the art, and may comprise different or incompatible operating systems, input mechanisms, communications mechanisms, storage mechanisms, data-formatting conventions, methods of data organization, update schedules, or other characteristics.

A data-aggregation subsystem 117 may take any form known to those skilled in the art, such that a subsystem 117 is capable of receiving, aggregating, and recording disparate forms of input from one or more project managers or team members. A data-aggregation subsystem 117 might, for example, comprise a combination of: a personal computer; a workstation; a mobile device; a workstation of a project-management, transaction-processing, or other type of software application; a manual or semi-automated mechanism, such as a handwritten or typed time-entry log, project schedule, Gantt chart, or budget, or a worksheet of a spreadsheet application; an automatic logging utility; a shared data-entry terminal; or a database or knowledgebase.

In embodiments of the present invention, such a subsystem 117 may transfer some or all of its aggregated data to the data warehouse 111 periodically, at a scheduled time, or in response to an ad hoc demand. In such embodiments, data warehouse 111 may organize, format, filter, store, or otherwise process information received from one or more data-aggregation subsystems, so as to ensure that information stored in the data warehouse 117 conforms to an expected format and organization.

Embodiments of the present invention may be implemented as a method performed by a processor of a special-purpose computer system similar to the system of FIG. 1, as a computer program product, as a computer system, or as a processor-performed process or service for supporting computer infrastructure.

FIG. 2 is a flow chart that illustrates steps of a method for real-time continuous realignment of a large-scale distributed project in accordance with embodiments of the present invention. FIG. 2 comprises steps 201-219.

In step 201, a special-purpose computerized system 100 receives a set of artifacts that characterize one or more projects to be considered by the embodiment of FIG. 2.

This specialized computer system, as described in FIG. 1, comprises a generic computer system (which includes a processor, memory, input/output peripherals, and a storage device) configured with a specialized data warehouse 111 subsystem that receives, aggregates, and processes continuously updated project information from one or more data-aggregation subsystems 117. A data warehouse 111 may comprise a combination of hardware, software, and virtualized components that work together to provide an information repository that stores and organizes data in a specialized format that is compatible with embodiments described in FIG. 2.

In some embodiments, some or all of the artifacts may be received from persons with expert knowledge of the one or more projects, or of a business entity related to the one or more projects. In such cases, one or more artifacts may be received by means of manually initiated electronic transfers, or by means of human communications between such a person with expert knowledge and an operator of the specialized computerized system. Such human communications may comprise any formal or informal means known to those skilled in the field, such as a Webinar, a live workshop, an electronic collaborative session, and combinations thereof. If artifacts are not communicated directly to the specialized system 100 by such communications mechanisms, they may be manually entered into the system 100.

In some embodiments, some or all of the artifacts may be: received as electronic records maintained by a business unit or by project-management personnel; received from one or more of the data-aggregation subsystems 117; manually entered into the specialized computerized system 100 by a project manager or other business personnel who identify those artifacts from paper or electronic records; or electronically transferred to the special-purpose computerized system 100 by automatic, mechanized, or manual methods known to those skilled in the art.

In embodiments wherein the specialized system 100 receives artifacts from data-aggregation subsystems 117, system 100 may receive such artifacts simultaneously or concurrently from all, or from a subset, of the data-aggregation subsystems 117. In some embodiments, the specialized system 100 may receive artifacts from two or more of the data-aggregation subsystems 117 at different times. In some embodiments, the specialized system 100 may receive artifacts at times that are a function of a predefined schedule, of an ad hoc demand, of a detection of a satisfaction of a condition, of an other implementation-dependent factor, or of combinations thereof.

In some embodiments, the method of FIG. 2 does not proceed beyond step 201 until it has received a current set of all artifacts associated with the one or more projects under consideration. In other embodiments, the method of FIG. 2 may proceed beyond step 201 even if has not received one or more of the current set of all artifacts associated with the one or more projects under consideration. In this case, the specialized processor 100 identifies values for the artifacts that were not received through known methods, such as interpolation, inferring values based on historical data, or deduction based on known values of received artifacts.

The received project artifacts may comprise any recorded information, conventions, procedures, or contractual terms associated with the project or projects under consideration. An artifact might, for example, comprise one or more: work orders; governance rules; procedures, conventions, or standards; contracts; cost estimates; labor estimates; accounting records; historical data; resource pricing; profitability goals; productivity goals; or components of a project plan. In some embodiments, an artifact may not be a signed or executed document, or may be a draft document. In some embodiments, each time step 201 is performed, previously received artifacts may be updated with newer versions or drafts.

In some cases, an artifact may be encoded with specialized codes that help an embodiment of the present invention more easily identify desired information embedded into the artifact. In a simple example, a project-plan document might label with a distinct code all figures that represent bottom-line project costs from which profitability goals might be derived. If a goal of an embodiment of the present invention is to ensure that the associated project is profitable, such labeling might facilitate identification of the cost figures, even if the project plan document is composed of free-form text.

In step 203, the specialized system 100 derives a set of baselines that identify one or more goals or obligations of the one or more projects under consideration. These goals or obligations may comprise, but are not limited to, combinations of: profitability goals; contractual terms or obligations; other financial goals, including budgetary, & cost constraints; delivery schedules; performance goals or benchmarks; descriptions of deliverables; resource limitations; resource-cost limitations; staffing requirements or constraints; a known service level; a number of support tickets serviced during a particular duration of time; an amount of consumption of a resource during a specified period of time; labor requirements; and other benchmarks and milestones.

These baselines are derived from the artifacts received in step 201 through known or novel combinations of techniques or methodologies known to those skilled in the art or possessed of expert knowledge.

In an exemplary embodiment, these baselines might be derived by a procedure:
i) Organize the artifacts received in step 201 into broad categories that correspond to indexes or categories of information stored in the data warehouse 111. Such categories might, for example, be organized functionally, comprising categories of: contracts; work orders; change orders; budgets; These categories might be further subdivided by project, geographic location, business or business unit, cost center, project team, period of time, billing mechanism, or other relevant parameter or characteristic. In some embodiments, artifacts associated with previously completed projects may be further organized into one or more distinct categories or subcategories.
ii) Filter the received artifacts in order to retain only those artifacts that are germane to an operation of the embodiment. In one example, if a project under consideration is one of six concurrent projects, artifacts and portions of artifacts that relate exclusively to any of the five other concurrent projects would be removed from consideration by the embodiment. Similarly, if a project under consideration has successfully completed the first three phases of a five-stage implementation plan, artifacts that relate exclusively to any of the first three phases would be removed from consideration. In some embodiments, steps i) and ii) may be performed concurrently or in reverse order.
iii) Extract from the filtered artifacts essential elements that identify parameters and benchmarks of interest. This extraction may be a function of a business goal, a characteristic of a project, a hardware, software, financial, business, or resource constraint, or other implementation-dependent factor. If, for example, a goal of an embodiment is to measure and ensure a project's profitability, parameters and benchmarks related to past, current, and future costs, levels of resource consumption, and contractual budgetary commitments might be considered to be of interest. If not done so already, these extracted elements may be collated into a structure, organization, or format that facilitates storage in the data warehouse 111.
iv) Determine baseline values of the parameters and benchmarks of interest as a function of information in the filtered artifacts. These baselines may represent goals or obligations related to resource requirements, rates of resource consumption, labor costs, delivery schedules, overhead cost, resource availability, team-member productivity, profitability, and many other known project-measurement parameters. In a simple example, if a contract states that a project must produce 100 units during a specified time at a specified cost, the specialized system 100 in this step would represent this obligation as a baseline deliverables obligation. Hundreds, or even thousands, of such baseline values may be associated with a larger or more complex project and complex relationships may exist among subsets of baseline parameters, such that a change to a value of one baseline parameter has a cascading direct or indirect effect upon other baseline parameters.
v) Format and organize the determined baseline values into a form that is compatible with the internal organization of the data warehouse 111. This formatting and organization may comprise revisions that range from trivial to complex. A United States currency value, for example, that identifies dollars and cents values, may be truncated by one embodiment if the data warehouse 111 stores currency figures as pure dollar values. In another embodiment, implementation-dependent details or a data-warehouse convention may require the currency value to be rounded, rather than truncated.

In other cases, however, more complex operations may be required in order to reconcile formats of received data with formatting requirements of the data warehouse 111. A received contract term that specifies scheduling, dependency, and cost requirements for a set of deliverables may be partitioned into multiple values, each of which is associated with a distinct baseline, and those baseline values may be aggregated with other baseline values, indexed for retrieval by certain standard types of queries, and stored in the data warehouse 111 as several linked tabular structures.

In some embodiments, a procedure of step 203 may further comprise one or more interactive or collaborative sessions in which business managers, project managers, or other responsible personnel interact to identify, select, interpret, or direct processing of parameters or benchmarks relevant to the project or projects, or of baseline values of selected parameters or benchmarks. These sessions may be conducted through any means known to those skilled in the art, such as a workshop, a teleconference held by means of an audioconferencing, videoconferencing, or Web conferencing application, an other network-based collaborative effort, a computer-implemented directed interrogatory, wizard, or other information-gathering mechanism, or other means appropriate to a particular embodiment of the present invention.

At the conclusion of step 203, the specialized system 100 will have populated a computerized model of the project or projects under consideration by the current embodiment. This populated model will identify a scope, target values, obligations, or goals of the project or projects as functions of information extracted from the project artifacts received in step 201, where that extracted information will have been filtered, organized, and formatted into a form that may be imported into the data warehouse 111 model.

In some embodiments, the procedure of steps 201 and 203 might result in a creation of an index, hierarchical structure, or key structure that identify or characterize relationships among baseline values derived from the received artifacts. In some cases, these relationships may comprise relationship-dependencies, time or resource constraints, or other factors that allow tasks associated with the baseline values to be represented in known ways, such as elements of a Gantt chart. In other embodiments, these relationships may be used to organize baseline values, and other data elements identified or derived by the embodiment, into a directed graph, schema, ontology, or other searchable logical structure.

In some embodiments, steps 201 and 203 are performed only once during a lifetime of a project, but in other embodiments, these steps will be performed multiple times in order to update values of the parameters that define a project-wide set of baselines. Such multiple updates may be performed if, for example, goals, contractual commitments, and obligations of a project may vary over time as a function of a received change order, contingent commitments, a renegotiated statement of work, or other planned or ad hoc revisions. Because of the interactive, near-realtime nature of the present invention, it may be vital that such implementations ensure that they have derived only the most current baseline values that most accurately represent a project's latest goals, commitments, and obligations.

Step 205 begins an iterative process of steps 205-219 that repeats until actual progress of a project is known to comply with the baseline values identified in step 203. Each iteration of this iterative process compares actual progress against the baselines, creates recommendations as a function of an analysis of that comparison, and communicates those recommendations to project managers. Here, a next iteration determines if that set of recommendations were implemented properly and, if so, resolved inconsistencies between baseline and actual performance values. If the inconsistencies have been resolved, the method of FIG. 2 ends with this iteration of step 205. If the inconsistencies had not been resolved, the method of FIG. 2 continues with a next iteration of steps 207-219.

In some cases, there may be a delay between iterations of the process of steps 205-219, in order to give project managers time to implement the communicated recommendations, or to give the implemented recommendations sufficient time to have an effect upon a project's actual progress toward satisfying the baselines.

In some embodiments, step 205 may be omitted and steps 207-219 may be performed only once during a performance of the method of FIG. 2. In such embodiments, after the recommendations are communicated to project managers during a first iteration of steps 207-219, the method of FIG. 2 ends. The entirety of the method of FIG. 2 (without step 205) may then be performed again at a future, predetermined time or in response to an occurrence of a condition associated with the project or projects. Such embodiments may be most useful in projects in which baseline goals and obligations have a significant chance of varying before the communicated recommendations are likely to have been implemented or to have produced identifiable results.

In step 207, the specialized system 100 receives information from which may be extracted or inferred updated project-performance data from the data-aggregation subsystems 117. This received information may comprise any tracked, recorded, logged, reported, or other type of information accessible to project workers who enter data into a data-aggregation subsystem 117. This received information may also comprised data received directly or indirectly from other sources, such as: an extrinsic statistical analysis of industry, financial, or market characteristics; an archive of past performance characteristics of similar projects; or client records.

Such information may comprise, but is not limited to, work orders, change requests, financial statements, labor time sheets, inventory records, delivery records, logged costs, accounting records, or project-management notes. Some of received information items may comply with certain formatting and organization conventions or standards, but in some embodiments, some items may comprise free-form text from which meaning must be inferred by a means known to those skilled in the art, such as an inference engine of a knowledgebase.

This received information may have been collected via automated logging or tracking mechanisms, may have been imported from other applications and systems (such as a project-management application, an inventory program, a worker billable time-tracking mechanism, or a financial system), or may have been manually entered by project managers, other managers, or project team members.

This data may have been entered into each data-aggregation subsystem 117 from team members at multiple sites associated with a particular data-aggregation subsystem 117. If subsets of the data have been entered into a data-aggregation subsystem 117 asynchronously or at different times, the subsystem 117 will automatically update stored data with newly entered values, and may aggregate, record, and log each entered value in order to provide an audit trail from which the transactions that produced the most current data values may be reviewed in order to confirm the accuracy or reasonableness of the current values. In this way, each data-aggregation subsystem 117 acts as a hub that aggregates, time-sequences, organizes, and stores the most current information associated with actual progress being made toward achieving a goal or obligation of the project or projects. Regardless of when or how data related to actual progress is reported, or from which sources that data is derived, the data-aggregation subsystems 117 will always be able to provide upon demand the latest information required by embodiments that are in accordance with the method of FIG. 2.

As described above, these subsystems 117 may format data differently or organize it into incompatible structures or formats, and may comprise inconsistent or incompatible data-gathering mechanisms, update schedules, base platforms, operating environments, software applications, hardware components, connectivity, communications protocols, infrastructure, or other implementation-dependent characteristics.

In some embodiments, the method of FIG. 2 does not proceed beyond step 207 until it has received a most current set of actual-performance data from every data-aggregation subsystem 117. But in other embodiments, the method of FIG. 2 may proceed to step 209 if the specialized system 100 receives a most current set of actual performance data from a proper subset of the data-aggregation subsystems 117. In other words, while some embodiments do not further analyze project data until all available project actual-progress parameters have been updated to their most current values, other embodiments may initiate the analysis procedure of steps 209-215 after receiving any, or a certain subset of, the current actual-progress values stored on one or more of the data-aggregation subsystems 117.

In step 209, the special-purpose computerized system 100 extracts meaningful information from the actual-performance data received in step 207. As in step 203, the system 100 performs a series of procedures upon the received information in order to format and organize the received information into a form compatible with the project model stored in data warehouse 111.

As in step 203, this series of procedures may comprise aggregation, collation, filtering, organizing or structuring, or formatting the received information. Implementation-specific details may define the exact steps comprised by such a procedure and may further define the sequence in which the steps are performed. Such implementation-dependent details may be well understood by those skilled in the art.

At the completion of step 209, the actual performance data received in step 207 will have been placed in a form that is compatible with the project model stored in the data warehouse 111. Such a form will allow the specialized system to quickly compare baseline and actual values of each parameter or benchmark that will be used to characterize how successfully the project is working toward achieving its goals. In some embodiments, the special-purpose computerized system 100 will have also stored this formatted and organized actual performance data in the data warehouse 111, and this stored data may have been integrated into the project model.

In step 211, the specialized system 100 compares the baseline values of relevant project parameters and benchmarks derived in step 203 to the actual-progress values of those parameters and benchmarks derived in step 209.

This comparison is possible because the baseline data received in step 203 and the current actual-progress data received in step 211 have both been processed into a format and organization that is compatible with the project model maintained by the data warehouse 111.

In a simplified example, a baseline value of an installation-service profitability parameter may have been derived in step 203 as a difference between a projected labor cost to perform the installation service and a contracted flat rate billed to a customer for the performance of the service. Similarly, an actual-performance value of the installation-service profitability parameter may have been derived in step 209 as a function of aggregated labor costs billed to date to the installation service. If the baseline value is $72,000 and the actual cost of labor required to complete 50% of the project is $38,000, the comparison of step 211 reveals that the installation-service task of the project is currently $2,000 over budget.

In real-world implementations, these comparisons may be far more complex. They may involve parameters and benchmarks that are functions of a large number of measurables, and those measurables may be related in nuanced ways. For example, performance of an installation task may be a function of labor costs, equipment delivery schedules, prerequisite upgrades of other software, infrastructure, or hardware, availability of resources that are shared with other project tasks, and other factors that may themselves be related by other dependencies. If a corresponding baseline value is derived as a different function of these or other factors, an useful comparison of baseline and actual values may require auxiliary analyses that determine a project's true progress with greater granularity and precision. If, for example, labor costs are higher than projected due to a last-minute decision to upgrade a software tool, a more nuanced comparison and analysis might reveal that time savings generated by that upgraded tool might offset the time consumed to upgrade the tool.

One technical advantage of the present invention is thus its ability to analyze and compare extraordinarily complex project benchmarks that would be beyond the ability of traditional manual or semi-automated means, such as use of a conventional project-management application run by a human user. Another advantage is that embodiments of the present invention, through use of remote data-aggregation subsystems 117 and data-warehouse technology, may intelligently perform such comparisons and analyses quickly enough to provide simultaneous, coordinated, time-sensitive, recommendations to project managers located at remote sites distributed across the globe.

In step 213, if it has not already done so, the special-purpose computerized system 100 stores the results of the comparisons derived in step 213 in the data warehouse 117. In embodiments in which these comparisons are not comprised by the project model stored and maintained by data warehouse 117, they may be stored in a separate data structure that will be used by the analysis of step 215.

In step 215, the special-purpose computerized system 100 analyzes the data stored in step 213 into the data-warehouse analysis data structure. This analysis data structure may incorporate other relevant information necessary to analyze the data derived in step 211. Such other relevant information may comprise linkages and dependencies among data elements of the derived data, historical information from which future performance may be inferred, or other implementation-dependent factors specific to business or business unit, team members, resource constraints, extrinsic factors, or other elements, conditions, or considerations associated with the project or projects.

In some embodiments, a procedure of step 215 may further comprise one or more interactive or collaborative sessions in which business managers, project managers, or other responsible personnel interact to collaboratively provide input to the analysis of step 215. These sessions may be conducted through any means known to those skilled in the art, such as a workshop, a teleconference held by means of an audioconferencing, videoconferencing, or Web conferencing application, an other network-based collaborative effort, a computer-implemented directed interrogatory, wizard, or other information-gathering mechanism, or other means appropriate to a particular embodiment of the present invention. In some embodiments, such sessions may be possible only if a time to conduct such a session does not delay the automated generation and communication of recommendations in step 219 such that the method of FIG. 2 is unable to provide real-time, near real-time, or continuous recommendations in time for project managers to effectively realign project tactics and strategies.

This analysis may identify any of a broad variety of useful information from which project-management recommendations may be made. Such an analysis might, for example, determine that actual labor costs, as indicated by one or more elements of actual-performance data stored in the data warehouse in step 209, are exceeding projected labor costs, as identified by a baseline value of a labor-cost benchmark, stored in the data warehouse in step 203.

Such a determination might further trigger a subsequent step of the analysis intended to determine whether mitigating or other related factors exist that might influence an interpretation of this exceeding. If, for example, labor costs of one business unit are higher than projected because a project task of the business unit was expanded in scope so as to reduce workload on a second business unit, the analysis might reset the corresponding baseline values associated with the two business units to match more realistic post-expansion expectations.

In some embodiments, the financial analysis may comprise the following steps:
i) the distributed project-management system retrieving sets of corresponding baseline and actual values from the data warehouse, where they were translated into a data warehouse-compatible format and stored in the data warehouse in steps 203 and 209. If, for example, a goal of the embodiment is to identify profitability problems and then realign project parameters in order to mitigate or eliminate such problems, the system might in this step retrieve:
   “baseline,” “planned,” or “target” values of profitability benchmarks, where a first subset of those benchmarks each measure a cost component of a profitability associated with a contractual product-delivery commitment, and a second subset might identify revenues associated with the commitment. In this example, each cost component might identify a set of costs associated with: purchase of a raw material; an assembly process; or a packaging and delivery task. Each baseline value might thus identify an original contracted cost associated at the time the project is launched, with each benchmark, such as a price commitment of a resource supplier; or might identify an original contracted sale price of the products.
   “historical actual” values of some or all of the same profitability benchmarks. Here historical actual values identify aggregated values the benchmarks that may be related to previous work on the same project. In the preceding example, historical actuals might be used to identify a monotonically increasing trend in the price of a raw material over the past six months that might trigger an inference that any current budget overages related to the material price are likely to increase in the future. In some cases, a set of historical actual values of a benchmark might include a current value that identifies the value of the benchmark at the present time.
   “forecast” values of some or all of the same profitability benchmarks that identify estimated values of the benchmarks as a function of the baseline and historical actual values. In this example, a forecasted benchmark value might be distinguishable from a corresponding baseline value because the forecasted value is identified as a function of information known at the present time, while the baseline value was identified at the time the project was originally planned or contracted. In some embodiments, a forecasted value may be a projected value of a future project-related task. All projects require forecasted values, so that they can monitor and predict a likelihood that project progress will deviate from profitability targets. Such a deviation may be identified in time to be properly addressed by embodiments described herein in which a financial analysis compares a forecast value of a benchmark to a corresponding baseline value.
ii) the distributed system relating values of each set and determining whether the values indicate or suggest a risk of an undesirable condition. If, for example, a goal of the embodiment is to identify profitability problems and then realign project parameters in order to mitigate or eliminate such problems, the system accomplish this task by:
   comparing, for each profitability benchmark: historical actuals vs. planned values; forecast values vs. planned values; and historical actual vs. forecast. If any of these comparisons produce results that exceed a specified threshold value, or that satisfy a specified condition, the system will flag the benchmark as being in a state that may require remedial action. If the embodiment has related the flagged benchmark as depending upon values of other benchmarks (such as those that track other components of a profitability computation), then the system will further analyze the state of those other benchmarks in order to determine a most effective recommendation.

In step 217, the specialized system 100 determines whether the results of the analysis of step 215 indicates that all baselines are being met by current project progress. This determination may also be made upon an identification that extrinsic considerations may require reconsideration of an apparent success or failure to satisfy a baseline obligation. One example of such a consideration is given above in the description of how extra time spent performing a task may be known to be likely to save time in the future.

If the specialized system 100 determines in step 217 that all baselines are being satisfied by current actual progress in the performance of the project or projects, then the current iteration of the process of steps 205-219 ends. As described above, in some embodiments, either the method of FIG. 2 will terminate, or a next iteration of step 205 will be performed and will determine that no further iterations of the iterative process of steps 205-219 should be performed.

If the specialized system 100 determines in step 217 that one or more baselines are not being satisfied by current actual progress, then step 219 is performed, the current iteration of the process of steps 205-219 ends and a next iteration begins. In some embodiments, as described above, the next iteration, rather than beginning immediately after a performance of step 219, will be scheduled or otherwise determined to begin at a later time or when a certain condition occurs. In yet other embodiments, the method of FIG. 2 will terminate at a conclusion of step 219, but the method of FIG. 2 will be scheduled or otherwise determined to be repeated in its entirety, starting with step 201, at a later time.

In step 219, the special-purpose system 100 generates recommendations based on the results of the analysis of step 215. These recommendations are derived through implementation-dependent methods, based on techniques known to those skilled in the art, or based on expert knowledge of a system implementer, project manager, or other qualified individual.

A goal of these recommendations is to instruct project managers or other responsible parties to take specific actions intended to place actual project performance in compliance with baseline goals or obligations.

These recommendations, as described above, may take into consideration dependencies and other relationships among parameters and benchmarks by which project progress may be measured. They are configured to provide simultaneous or current instructions to distributed project teams operating at geographically remote sites, working within different business units, or employing different hardware, software, communications mechanisms, procedures, or resources. One advantage of the present invention over existing manual or semi-automated methods is its ability to communicate such integrated, simultaneous, coordinated recommendations to geographically and technically distributed project teams working on related, sequenced, or time-critical tasks.

As mentioned above, step 219 concludes by communicating the generated recommendations to appropriate team members, using any electronic or physical communications mechanism known to those skilled in the art.

In some cases, the communicating of step 219 may be performed by forwarding specific recommendations, based on the analysis of step 215, to the data-aggregation subsystems 117, where project managers or team members may review or implement the recommendations. Further actions of the recipients may be implementation-dependent. In some embodiments, for example, the recipients may review the recommendations and respond by any means known to those skilled in the art. This response may, for example, comprise manually entering a quantitative representation of the recommendations into a project-management document or tool (such as a worksheet of a spreadsheet application or a Gantt chart) and reporting the results of this manual entering to a data-aggregation subsystem 117. In such a case, these results might be returned to the computer system 101 of the distributed project-management system 100 during the next iteration of step 207.

In other cases, the recommendations generated in step 219 may be forwarded directly to one or more electronic project-management tools, thus providing automated realignment of project parameters. In such a case, the resulting realignment may be reviewed manually by project managers or team members, who may respond as described above, or may be determined automatically by an electronic project-management tool that automatically analyzes and reports the results of the realignment to one or more data-aggregation subsystem 117.

What is claimed is:

1. A distributed project-management system comprising a computer system, a data warehouse and data-warehouse server, a set of data-aggregation subsystems located at multiple distinct sites, and communications infrastructure connecting the computer system, server, and data-aggregation subsystems, wherein the computer system comprises a processor, a memory coupled to the processor, and a computer-readable hardware storage device coupled to said processor, and wherein the storage device contains program code configured to be run by the processor via the memory to implement a method for real-time continuous realignment of a large-scale distributed project, said method comprising:
a distributed project-management system accessing a set of project-related artifacts that comprises records describing goals and obligations of the project, wherein the distributed system comprises a computer system, a data warehouse and data-warehouse server, a set of data-aggregation subsystems located at multiple distinct sites, and communications infrastructure connecting the computer system, server, and data-aggregation subsystems;
the distributed system deriving a set of baseline values from the set of project-related artifacts,
wherein a first baseline value of the set of baseline values identifies a first project goal of a set of project goals, and
wherein a degree of progress toward attaining the first project goal is measured by a first benchmark of a set of project benchmarks;
the distributed system storing the set of baseline values in the data warehouse in a first data configuration;
the computer system receiving a set of project-performance records from the data-aggregation subsystems;
the distributed system extracting from the set of project-performance records a set of actual values,
wherein a first current value of the set of actual values identifies, as measured by the first benchmark, the current degree of progress toward attaining the first project goal;
the distributed system identifying, by comparing the first baseline value to the first current value, the degree of progress toward attaining the first project goal;
the distributed system conducting a project-progress analysis as a function of the identifying;
the distributed system determining, as a function of the conducting, that the current degree of progress toward attaining the first project goal is insufficient to ensure satisfaction of the first project goal; and
the distributed system, as a function of the determining, communicating a recommendation to a project manager, wherein the recommendation identifies action that should be taken by the project manager in order to ensure satisfaction of the first project goal.

2. The system of claim 1, wherein the storing further comprises:
the distributed system formatting the set of baseline values into a first data configuration that is compatible with an internal organization of the data warehouse;
the distributed system forwarding the formatted set of baseline values to the data warehouse; and
the distributed system directing the data warehouse to store the formatted set of baseline values in the first data configuration.

3. The system of claim 1, wherein the receiving further comprises:
the computer system requesting any available subset of the set of project-performance records from one or more data-aggregation subsystems of the set of data-aggregation subsystems; and
the computer system receiving from a first subsystem of the set of data-aggregation subsystems at least one project-performance record that had been previously collected, aggregated, organized, formatted into a second data configuration, and locally stored by the first subsystem subsequent to the distributed system's most recent previous receipt of project-performance records from the first subsystem.

4. The system of claim 1, wherein the extracting further comprises:
the distributed system selecting a subset of records of the set of project-performance records, wherein each record of the subset of records that directly or indirectly indicates a current actual value of a corresponding benchmark of the set of project benchmarks;
the distributed system identifying and aggregating each of the directly or indirectly indicated current actual values;
the distributed system collating, organizing, and formatting the identified values directly or indirectly indicated current actual values into the first data configuration.

5. The system of claim 1, wherein an artifact of the set of project-related artifacts is selected from a group comprising: a contract, a contractual exhibit, a work order, a master agreement, a statement of work, a change request, a commitment to deliver a product or service, a budget, a schedule, a forecasted cost of a resource, and a labor estimate.

6. The system of claim 1, wherein the set of project-related artifacts further comprises historical project-performance data related to previous projects that share a characteristic of the large-scale distributed project.

7. The system of claim 1, wherein a record of the set of project-performance records is selected from a group comprising: a time sheet, a change order, a task status, and a statement of accumulated costs.

8. The system of claim 1, wherein the project-progress analysis identifies the project's profitability as a function of the current degree of progress toward attaining the first project goal.

9. The system of claim 1, wherein the first project goal identifies a contractual obligation to deliver a product or service.

10. The system of claim 1, wherein the deriving comprises an interactive collaborative review, among two or more persons with project-management responsibility, of the received set of project-related artifacts.

11. The system of claim 10, wherein the interactive collaborative review is a live workshop, an Internet-based Webinar, or a teleconference.

12. The system of claim 1, wherein the financial analysis is a profitability analysis that comprises:
the distributed system producing a first comparison result by comparing a baseline profitability value of the set of baseline values to an actual profitability value of the set of actual values;
the distributed system producing a second comparison result by comparing the baseline profitability value to a forecasted profitability value of a set of forecasted values;
the distributed system producing a third comparison result comparing the actual profitability value to the forecasted profitability value; and
the distributed system determining whether the large-scale distributed project will be profitable by corroborating and analyzing the first, second, and third comparison results,
wherein the baseline profitability value, the actual profitability value, and the forecasted profitability value identify distinct values of a profitability benchmark of the set of project benchmarks, and
wherein the profitability benchmark identifies a degree of profitability of the large-scale distributed project.

13. The system of claim 1, further comprising:
the distributed system repeating the receiving, extracting, identifying, conducting, determining, and communicating until the system determines, as a function of the conducting, that the degree of progress toward attaining the first project goal is sufficient to ensure satisfaction of the corresponding project goal.

14. A method for real-time continuous realignment of a large-scale distributed project, the method comprising:
a distributed project-management system accessing a set of project-related artifacts that comprises records describing goals and obligations of the project, wherein the distributed system comprises a computer system, a data warehouse and data-warehouse server, a set of data-aggregation subsystems located at multiple distinct sites, and communications infrastructure connecting the computer system, server, and data-aggregation subsystems;
the distributed system deriving a set of baseline values from the set of project-related artifacts,
wherein a first baseline value of the set of baseline values identifies a first project goal of a set of project goals, and
wherein a degree of progress toward attaining the first project goal is measured by a first benchmark of a set of project benchmarks;
the distributed system storing the set of baseline values in the data warehouse in a first data configuration;
the computer system receiving from the set of data-aggregation subsystems a set of project-performance records from the data-aggregation subsystems;
the distributed system extracting from the set of project-performance records a set of actual values,
wherein a first current value of the set of actual values identifies, as measured by the first benchmark, the current degree of progress toward attaining the first project goal;
the distributed system identifying, by comparing the first baseline value to the first current value, the degree of progress toward attaining the first project goal;
the distributed system conducting a project-progress analysis as a function of the identifying;
the distributed system determining, as a function of the conducting, that the current degree of progress toward attaining the first project goal is insufficient to ensure satisfaction of the first project goal; and
the distributed system, as a function of the determining, communicating a recommendation to a project manager, wherein the recommendation identifies action that should be taken by the project manager in order to ensure satisfaction of the first project goal.

15. The method of claim 14, wherein the storing further comprises:
the distributed system formatting the set of baseline values into a first data configuration that is compatible with an internal organization of the data warehouse;
the distributed system forwarding the formatted set of baseline values to the data warehouse; and
the distributed system directing the data warehouse to store the formatted set of baseline values in the first data configuration.

16. The method of claim 14, wherein an artifact of the set of project-related artifacts is selected from a group comprising: a contract, a contractual exhibit, a work order, a master agreement, a statement of work, a change request, a commitment to deliver a product or service, a budget, a schedule, a forecasted cost of a resource, and a labor estimate.

17. The method of claim 14, wherein a record of the set of project-performance records is selected from a group comprising: a time sheet, a change order, a task status, and a statement of accumulated costs.

18. The method of claim 14, wherein the deriving comprises an interactive collaborative review, among two or more persons with project-management responsibility, of the received set of project-related artifacts.

19. The method of claim 14, further comprising providing at least one support service for at least one of creating, integrating, hosting, maintaining, and deploying computer-readable program code in the computer system, wherein the computer-readable program code in combination with the computer system is configured to implement the accessing, deriving, storing, receiving extracting, identifying, conducting, determining, and communicating.

20. A computer program product, comprising a computer-readable hardware storage device having a computer-readable program code stored therein, said program code configured to be executed by a processor of a computer system to implement a method for real-time continuous realignment of a large-scale distributed project, the method comprising:
a distributed project-management system accessing a set of project-related artifacts that comprises records describing goals and obligations of the project, wherein the distributed system comprises a computer system, a data warehouse and data-warehouse server, a set of data-aggregation subsystems located at multiple distinct sites, and communications infrastructure connecting the computer system, server, and data-aggregation subsystems;
the distributed system deriving a set of baseline values from the set of project-related artifacts,
wherein a first baseline value of the set of baseline values identifies a first project goal of a set of project goals, and
wherein a degree of progress toward attaining the first project goal is measured by a first benchmark of a set of project benchmarks;
the distributed system storing the set of baseline values in the data warehouse in a first data configuration;
the computer system receiving a set of project-performance records from the data-aggregation subsystems;
the distributed system extracting from the set of project-performance records a set of actual values,
wherein a first current value of the set of actual values identifies, as measured by the first benchmark, the current degree of progress toward attaining the first project goal;
the distributed system identifying, by comparing the first baseline value to the first current value, the degree of progress toward attaining the first project goal;
the distributed system conducting a project-progress analysis as a function of the identifying;
the distributed system determining, as a function of the conducting, that the current degree of progress toward attaining the first project goal is insufficient to ensure satisfaction of the first project goal; and
the distributed system, as a function of the determining, communicating a recommendation to a project manager, wherein the recommendation identifies action that should be taken by the project manager in order to ensure satisfaction of the first project goal.
